(19) United States
(12) Patent Application Publication
(10) Pub. No.: US 2025/0278169 A1
(43) Pub. Date: Sep. 4, 2025

(54) ELECTRONIC DEVICE AND METHOD FOR IMAGE VIEWING

(71) Applicant: HTC Corporation, Taoyuan City (TW)

(72) Inventor: Yujyun Jhan, Taoyuan City (TW)

(73) Assignee: HTC Corporation, Taoyuan City (TW)

(21) Appl. No.: 19/031,182

(22) Filed: Jan. 17, 2025

Related U.S. Application Data
(60) Provisional application No. 63/560,758, filed on Mar. 3, 2024.

(51) Int. Cl. G06F 3/0482; G06F 16/54

(52) U.S. Cl. CPC G06F 3/0482; G06F 16/54

(57) ABSTRACT

An electronic device and a method for image viewing are provided. The method includes: obtaining a plurality of images, wherein the plurality of images include a first image, wherein the first image includes a first value and a second value; generating a directory of data by assigning the first image to a first directory of the directory of data and assigning the first image to a first subdirectory of the first directory according to the second value; in response to the first image being selected, preloading a second image within a second directory of the directory of data to a cache memory according to the directory of data; and outputting a graphical user interface, wherein the graphical user interface displays the first image in response to the first image being selected.

### CROSS-REFERENCE TO RELATED APPLICATION

This application claims the priority benefit of U.S. provisional application Ser. No. 63/560,758, filed on Mar. 3, 2024. The entirety of the above-mentioned patent application is hereby incorporated by reference herein and made a part of this specification.

### BACKGROUND

### Technical Field

The disclosure is related to image processing technology, and particularly related to an electronic device and a method for image viewing.

### Description of Related Art

When using an image viewer, displaying multiple images simultaneously in one page may often result in significant loading times. As users switch between pages by the image viewer, the loading process may cause delays, leading to a poor user experience due to interruptions. As improving the speed and smoothness of image transitions is critical for enhancing overall user satisfaction, reducing image loading times has become a key challenge in the field.

### SUMMARY

The disclosure is directed to an electronic device and a method for image viewing.

The present invention is directed to an electronic device for image viewing, including a transceiver, a cache memory, and a processor. The processor is coupled to the transceiver and the cache memory, wherein the processor is configured to: obtain a plurality of images through the transceiver, wherein the plurality of images include a first image, wherein the first image includes a first value and a second value; generate a directory of data by assigning the first image to a first directory of the directory of data according to the first value and assigning the first image to a first subdirectory of the first directory according to the second value; in response to the first image being selected, preload a second image within a second directory of the directory of data to the cache memory according to the directory of data; and output a graphical user interface through the transceiver, wherein the graphical user interface displays the first image in response to the first image being selected.

In one embodiment of the present invention, the processor is further configured to: determine an offset between an order of the first directory in the directory of data and an order of the second directory in the directory of data; determine whether the offset is less than or equal to a first range limit; and in response to the offset being less than or equal to the first range limit, preload the second image within the second directory.

In one embodiment of the present invention, the processor is further configured to: preload a third image within a third directory of the directory of data to the cache memory, wherein an order of the third directory in the directory of data is previous to an order of the second directory in the directory of data.

In one embodiment of the present invention, the processor is further configured to: in response to the first image being selected, preload a fourth image within the first subdirectory to the cache memory according to the directory of data.

In one embodiment of the present invention, the processor is further configured to: determine an offset between an order of the first image in the first subdirectory and an order of the fourth image in the first subdirectory; determine whether the offset is less than or equal to a second range limit; and in response to the offset being less than or equal to the second range limit, preload the fourth image.

In one embodiment of the present invention, the processor is further configured to: output a graphical user interface through the transceiver, wherein the graphical user interface displays a plurality of videos according to a count value.

In one embodiment of the present invention, the processor is further configured to: determine the second range limit according to the count value.

In one embodiment of the present invention, the processor is further configured to: in response to the offset being less than the second range limit but the fourth image being the first or the last one among images within the first subdirectory or in response to the first image being the first or the last one among the images within the first subdirectory, save a preloading quota; determine a number of preloaded images of the first directory; and in response to the number of the preloaded images being less than or equal to a count limit, preload the second images within the second directory by the preloading quota.

In one embodiment of the present invention, the processor is further configured to: preload a fifth image within the first subdirectory to the cache memory after the fourth image being preloaded, wherein an order of the fifth image in the first subdirectory is previous to an order of the fourth image in the first subdirectory.

In one embodiment of the present invention, the first image further includes a third value, wherein the processor is further configured to: sort the first image in the first subdirectory according to the third value to generate the directory of data.

The present invention is director to a method for image viewing, including: obtaining a plurality of images, wherein the plurality of images include a first image, wherein the first image includes a first value and a second value; generating a directory of data by assigning the first image to a first directory of the directory of data and assigning the first image to a first subdirectory of the first directory according to the second value; in response to the first image being selected, preloading a second image within a second directory of the directory of data to a cache memory according to the directory of data; and outputting a graphical user interface, wherein the graphical user interface displays the first image in response to the first image being selected.

In one embodiment of the present invention, the step of preloading the second image within the second directory of the directory of data to the cache memory according to the directory of data including: determining an offset between an order of the first directory in the directory of data and an order of the second directory in the directory of data; determine whether the offset is less than or equal to a first range limit; and in response to the offset being less than or equal to the first range limit, preloading the second image within the second directory.

In one embodiment of the present invention, the method further including: preloading a third image within a third directory of the directory of data to the cache memory, wherein an order of the third directory in the directory of data is previous to an order of the second directory in the directory of data.

In one embodiment of the present invention, the method further including: in response to the first image being selected, preloading a fourth image within the first subdirectory to the cache memory according to the directory of data.

In one embodiment of the present invention, the step of preloading the fourth image within the first subdirectory to the cache memory according to the directory of data including: determining an offset between an order of the first image in the first subdirectory and an order of the fourth image in the first subdirectory; and determining whether the offset is less than or equal to a second range limit; and in response to the offset being less than or equal to the second range limit, preloading the fourth image.

In one embodiment of the present invention, the method further including: outputting a graphical user interface, wherein the graphical user interface displays a plurality of videos according to a count value.

In one embodiment of the present invention, the method further including: determining the second range limit according to the count value.

In one embodiment of the present invention, the step of preloading the second image within the second directory of the directory of data to the cache memory according to the directory of data including: in response to the offset being less than the second range limit but the fourth image being the first or the last one within the first subdirectory or in response to the first image being the first or the last one among the images within the first subdirectory, saving a preloading quota; determining a number of preloaded images of the first directory; and in response to the number of the preloaded images being less than or equal to a count limit, preloading the second images within the second directory by the preloading quota.

In one embodiment of the present invention, the method further including: preloading a fifth image within the first subdirectory to the cache memory after the fourth image being preloaded, wherein an order of the fifth image in the first subdirectory is previous to an order of the fourth image in the first subdirectory.

In one embodiment of the present invention, the first image further includes a third value, wherein the method further includes: sorting the first image in the first subdirectory according to the third value to generate the directory of data.

Based on the above description, the disclosure designs a special format for image to create a directory of data. The electronic device may preload a plurality of images based on image currently being viewed by the user.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 illustrates a schematic diagram of an electronic device for image viewing according to one embodiment of the present disclosure.

FIG. 2 illustrates a schematic diagram of a format or an image file according to one embodiment of the present disclosure.

FIG. 3 illustrates data structure of image files according to one embodiment of the present disclosure.

FIG. 4 illustrates a graphical user interface of an image viewer according to one embodiment of the present disclosure.

FIG. 5 illustrates a flowchart for image preloading according to one embodiment of the present disclosure.

FIG. 6 illustrates an example of image preloading according to one embodiment of the present disclosure.

FIG. 7 illustrates another example of image preloading according to one embodiment of the present disclosure.

FIG. 8 illustrates another example of image preloading according to one embodiment of the present disclosure.

FIG. 9 illustrates a flowchart of a method for image viewing according to one embodiment of the present disclosure.

### DESCRIPTION OF THE EMBODIMENTS

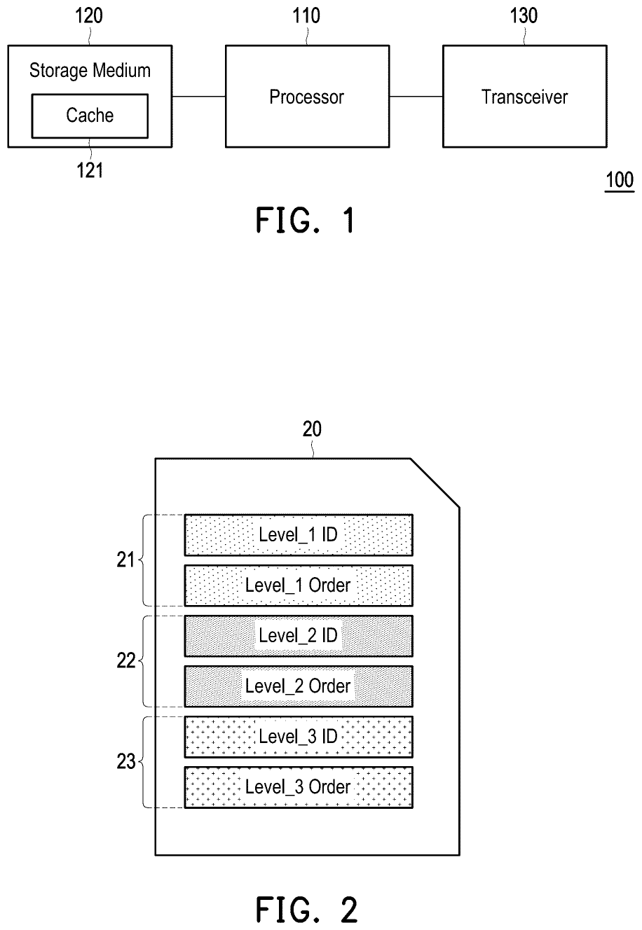

FIG. 1 illustrates a schematic diagram of an electronic device 100 for image viewing according to one embodiment of the present disclosure. The electronic device 100 may include a processor 110, a storage medium 120, and a transceiver 130. The processor 110 may be, for example, a central processing unit (CPU), or other programmable general purpose or special purpose micro control unit (MCU), a microprocessor, a digital signal processor (DSP), a programmable controller, an application specific integrated circuit (ASIC), a graphics unit (GPU), an arithmetic logic unit (ALU), a complex programmable logic device (CPLD), a field programmable gate array (FPGA), or other similar device or a combination of the above devices. The processor 110 may be coupled to the storage medium 120 and the transceiver 130.

The storage medium 120 may be, for example, any type of fixed or removable random-access memory (RAM), a read-only memory (ROM), a flash memory, a hard disk drive (HDD), a solid-state drive (SSD) or similar element, or a combination thereof. The storage medium 120 may be a non-transitory computer readable storage medium configured to record a plurality of executable computer programs, modules, or applications to be loaded by the processor 110 to perform the functions of the electronic device 100. The storage medium 120 may include a cache memory 121. The processor 110 may preload one or more videos (or image sets) or images to the cache memory for image viewing purpose.

The transceiver 130 may be configured to transmit or receive wired/wireless signals. The transceiver 130 may also perform operations such as low noise amplifying, impedance matching, frequency mixing, up or down frequency conversion, filtering amplifying, and so forth. The processor 110 may communicate with other devices via the transceiver 130. For example, the processor 110 may obtain or one or more videos, images, or user commands through the transceiver 130. For another example, the processor 110 may output a graphical user interface (GUI) to a display through the transceiver 130.

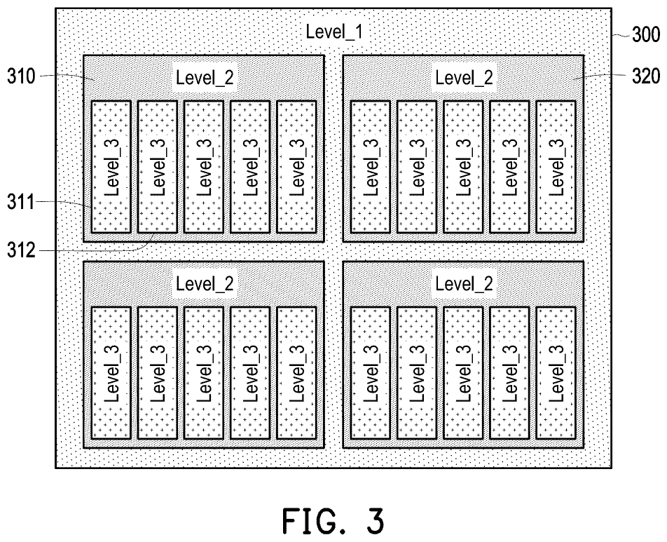

FIG. 2 illustrates a schematic diagram of a format or an image file according to one embodiment of the present disclosure. The image 20 may include information 21 which may be defined as level 1 information, information 22 which may be defined as level 2 information, and information 23 which may be defined as level 3 information. The information 21 may include values such as a level_1 identification (ID) or a level_1 order. The information 22 may include values such as a level_2 ID or a level_2 order. The information 23 may include values such as a level_3 ID or a level_3 order.

One or more level_2 IDs may belong to the same level_1 ID, and one or more level_3 IDs may belong to the same level_2 ID. Take FIG. 3 as an example, the images 311 and 312 with different level_3 IDs but the same level_2 ID may belong to the same level_2 image group 310. The image groups 310 and 320 with different level_2 IDs but the same level_3 ID may belong to the same level_1 image group 300.

In one embodiment, the level_1 ID may represent an index of a directory in an operating system, wherein the corresponding level_1 order may represent the order of the level_1 ID among a plurality of level_1 IDs. The level_2 ID may represent an index of a subdirectory in the directory, wherein the corresponding level_2 order may represent the order of the level_2 ID among a plurality of level_2 IDs belonging to the same level_1 ID. The level_3 ID may represent an index of an image in the subdirectory, wherein the corresponding level_3 order may represent the order of the level_3 ID among a plurality of level_3 IDs belonging to the same level_2 ID.

For example, assume that the plurality of images obtained by the processor 110 are related to transthoracic echocardiography (TTE) images of patients. The images with the same level_1 ID may correspond to the same patient. The images with the same level_1 ID but different level_2 IDs may correspond to different electrodes attached on the same patient. That is, the images with different level_2 IDs may correspond to different TTE videos of the same patient. The images with the same level_2 ID but different level_3 IDs may correspond to different frames (or time stamps, TTE images) of the same TTE video.

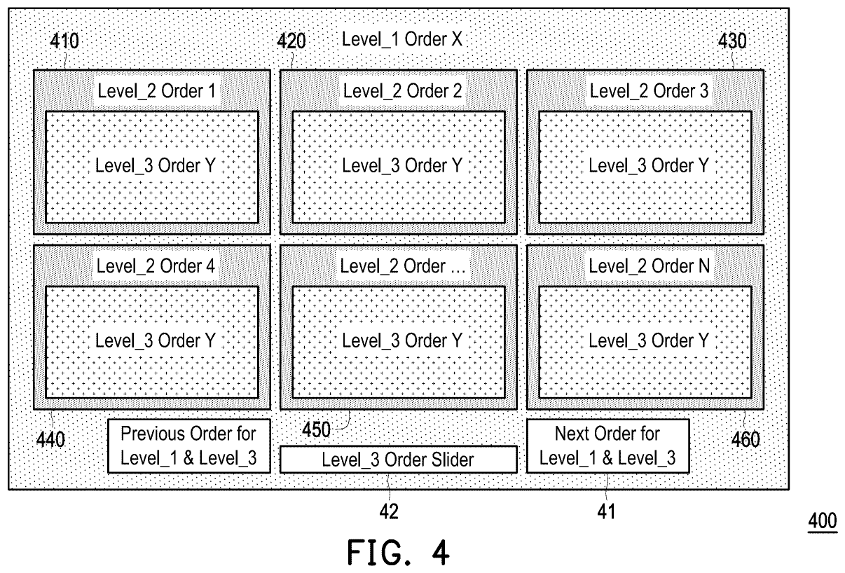

FIG. 4 illustrates a graphical user interface 400 of an image viewer according to one embodiment of the present disclosure. The GUI 400 may select and display one or more videos (or images) 410, 420, 430, 440, 450, and 460 corresponding to the same level_1 ID simultaneously based on a count value (e.g., count value C) and the level_2 order of each video. For example, the GUI 400 may display 6 videos simultaneously since the count value is equal to 6, wherein the videos 410, 420, 430, 440, 450, and 460 may be positioned on the GUI 400 according to level_2 order of each video. For example, the image 410 with the smallest level_2 order may be positioned in the upper-left corner of the GUI 400, and the image 460 with the largest level_2 order may be positioned in the lower-right corner of the GUI 400. In one embodiment, the displayed videos 410, 420, 430, 440, 450, and 460 may correspond to different level_2 IDs but the same level_3 ID. That is, the time stamps of the different videos 410, 420, 430, 440, 450, and 460 displayed simultaneously may be the same.

In one embodiment, the user may input a command to the electronic device 100 to manipulate the slider 42 of the GUI 400, so as to change the time stamp of the displayed videos. For example, assume that the videos 410-460 displayed by the GUI 400 currently are corresponded to frame Y. If the user drags the slider 42 to the right, the GUI 400 may switch the displayed videos 410-460 form frame Y to frame Y+1.

In one embodiment, the user may input a command to the electronic device 100 to manipulate the bottom 41 of the GUI 400, so as to change the videos being displayed. For example, assume that the videos 410-460, corresponding to TTE acoustic windows 1-6 respectively, are being displayed by the GUI 400. If the user clicks the bottom 41, the GUI 400 may switch the displayed videos from videos 410-460 to videos corresponding to TTE acoustic windows 7-12.

In one embodiment, if an image is selected (e.g., the image is displayed by the GUI 400 currently), the processor 110 may preload one or more images related to the selected image based on the parameters shown in Table 1.

TABLE 1
Level_1 Preload Range Limit: B (B is a positive integer and 0 ≤ B ≤ the
maximum value of level_1 order.
Level_3 Preload Range Limit (when C = 1): R (R is a positive integer and
0 ≤ R ≤ the maximum value of level_3 order.
Level_3 Preload Range Limit (when C > 1): L = └(0 − C)/2C┘
One Level_1 Group Preload Count limit: O = 2R + 1
All Level_1 Group Preload count limit: A = 2O + 1 = 4R + 3
Level_2 Count Value: C (C is a positive integer and 1 ≤ C ≤ the
maximum value of level_2 order.

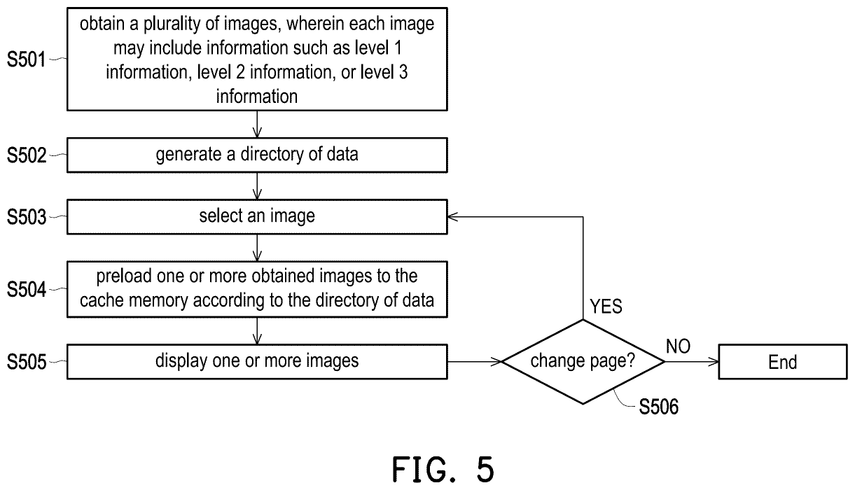

FIG. 5 illustrates a flowchart for image preloading according to one embodiment of the present disclosure, wherein the flowchart may be implemented by the electronic device 100 as shown in FIG. 1.

In step S501, the processor 110 may obtain a plurality of images through the transceiver 130, wherein each image may include information such as information 21, 22, or 23 (i.e., level 1 information, level 2 information, or level 3 information) as shown in FIG. 2. The obtained images may be stored in the storage medium 120.

In step S502, the processor 110 may generate a directory of data, wherein the directory of data may include one or more directory, and each directory may include one or more subdirectory. The processor 110 may generate the directory of data by assigning an image to a directory according to the information 21 and assigning the image to a subdirectory of the directory according to information 22. The processor 110 may sort the image in the subdirectory according to information 23.

For example, an image X may include values i, j, and k corresponding to information 21, 22, and 23, respectively. The processor 110 may allocate the path X(i, j, k) of image X to the k-th image in the j-th subdirectory in the i-th directory of the directory of data. That is, index i may be associated with level_1 ID or level_1 order of image X, index j may be associated with level_2 ID or level_2 order of image X, and index k may be associated with level_3 ID or level_3 order of image X. In one example, the path X(i, j, k) mentioned above may denote the k-th frame (or k-th time stamp) of the j-th TTE video (or j-th electrode) of the i-th patient.

In step S503, the user may select an image, wherein the selected image may be preloaded to the cache 121 or be displayed in the GUI 400. In the following paragraphs, It is assumed that the selected image is image X corresponding to path X(i, j, k).

In step S504, the processor 110 may preload one or more obtained images to the cache memory 121 according to the directory of data.

In one embodiment, the processor 110 may preload one or more images within the j-th subdirectory (e.g., the j-th TTE video of a patient) to the cache memory 121 according to the range limit R or L, wherein the processor 110 may determine which range limit, R or L, should be referred to according to the count value C. It should be noted that, in one embodiment, the number of preloaded images (including the image X(i, j, k) selected currently) belonging to the same level_1 ID cannot be greater than count limit O=2R+1, and the number of total preloaded images (including the image X(i, j, k)) cannot be greater than the count limit A, wherein the count limit A may be set to A=2O+1=4R+3 according to user defined.

Assume that C=1 (i.e., GUI 400 displays only one video or image in the same time). The processor 110 may determine an offset K between the level_3 order of the image X(i, j, k) in the j-th subdirectory and the level_3 order of an image X(i, j, k±K) in the j-th subdirectory, wherein K is a positive integer. If the offset K≤the range limit R, the processor 110 may preload the image X(i, j, k±K) to the cache 121. The order of the image X(i, j, k±K) in the j-the subdirectory to be preloaded may satisfy the following formula: max(1, k−R)≤k±K≤min(k+R, the largest level_3 order belonging to the same level_2 ID).

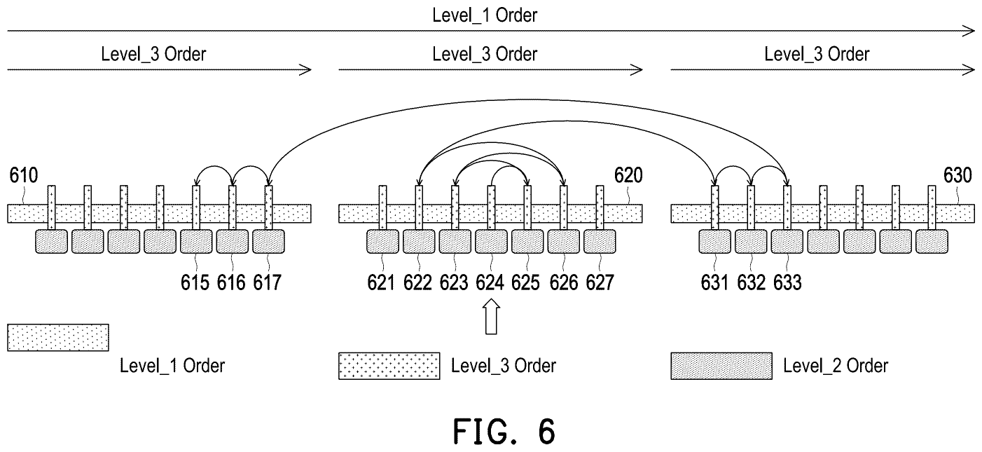

Take FIG. 6 as an example, assume that the count value C=1, the range limit R=2, and image 624 is currently selected or displayed by the GUI 400. The processor 110 may determine that the offsets K between the level_3 order (e.g., 4) of the image 624 and the level_3 orders (e.g., 2, 3, 5, and 6) of the images 622, 623, 625, and 626 are 2, 1, 1, and 2 respectively, which are less than or equal to the range limit R=2. Accordingly, the processor 110 may preload the images 622, 623, 625, or 626 to the cache 121. On the other hand, the processor 110 may determine that the offsets K between the level_3 order (e.g., 4) of the image 624 and the level_3 orders (e.g., 1 and 7) of the images 621 and 627 are 3 and 3 respectively, which are greater than the range limit R=2. Accordingly, the processor 110 may not preload the images 621 or 627 to the cache 121. The level_3 order 4±K of images to be preloaded (e.g., 622, 623, 625, or 626) may satisfy the following formula: max(1, 4−2)≤4+K≤min(4+2, 7).

Assume that C >1 (i.e., GUI 400 displays multiple videos or images in the same time). The processor 110 may determine an offset K between the level_3 order of the image X(i, j, k) in the j-th subdirectory and the level_3 order of an image X(i, j, k+K) in the j-th subdirectory, wherein K is a positive integer. If the offset K≤the range limit L=[(O−C)/2C], the processor 110 may preload the image X(i, j, k±K) to the cache 121. The level_3 order of the image X(i, j, k±K) in the j-th subdirectory to be preloaded may satisfy the following formula: max(1, k−L)≤k±K≤min(k+L, the largest level_3 order belonging to the same level_2 ID).

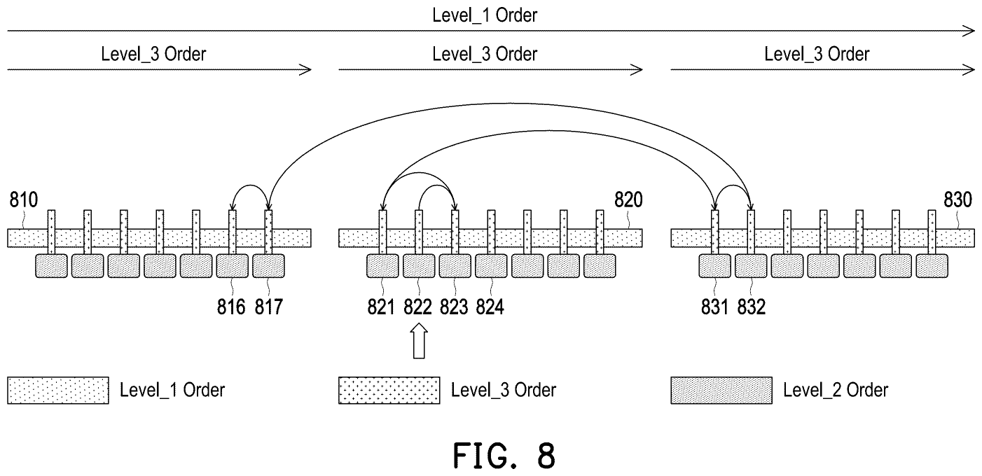

Take FIG. 8 as an example, assume that the count value C=2, the range limit R=3, the count limit O=2R+1=7, the range limit L=[(O−C)/2C]=1, and the image 822 is currently selected or displayed by the GUI 400. The processor 110 may determine the offsets K between the level_3 order (e.g., 2) of the image 822 and the level_3 orders (e.g., 1 and 3) of the images 821 and 823 are 1 and 1, which are equal to the range limit L=1. Accordingly, the processor 110 may preload the images 821 and 823 to the cache 121. On the other hand, the processor 110 may determine that the offset K between the level_3 order (e.g., 2) of the image 822 and the level_3 order (e.g., 4) of the image 824 is 2, which is greater than the range limit L=1. Accordingly, the processor 110 may not preload the image 824 to the cache 121. The level_3 order k+K of the images to be preloaded (e.g., 821 or 823) may satisfy the following formula: max(1, 2−1)≤4±K≤min(2+1, 7).

In one embodiment, the processor 110 may preload the image X(i, j, k−K) after the image X(i, j, k+K) being preloaded in response to the level_3 order of the image X(i, j, k−K) in the j-th subdirectory being previous to the level_3 order of the image X(i, j, k+K) in the j-th subdirectory. Take FIG. 6 as an example, since the level_3 order of the image 623 is previous to the level_3 order of the image 625, the processor 110 may preload the image 623 after the image 625 being preloaded.

In one embodiment, the processor 110 may preload the image X(i, j, k+(K+n)) after the image X(i, j, k+K) being preloaded in response to the offset K between the level_3 order of the image X(i, j, k+K) and the level_3 order of the image X(i, j, k) is less than the offset (K+n) between the level_3 order of the image X(i, j, k+(K+n)) and the level_3 order of the image X(i, j, k), where n is a positive integer. Take FIG. 6 as an example, since the offset ‘1’ between the level_3 order of the image 624 and the level_3 order of the image 623 is less than the offset ‘2’ between the image 622 and the image 624, the processor 110 may preload the image 622 after the image 623 being preloaded.

In one embodiment, if the offset K between the level_3 order of the image X(i, j, k) and the level_3 order of the image X(i, j, k±K) is less than the range limit (e.g., range limit R or L depending on the value of count value C), and the image X(i, j, k±K) is not the first or the last one among images within the j-th subdirectory (i.e., the image X(i, j, k±K) is not the image X(i, j, 1) or X(i, j, the largest level_3 order (e.g., 7)), the processor 110 may preload the image X(i, j, k±K). However, if the offset K between the level_3 order of the image X(i, j, k) and the level_3 order of the image X(i, j, k±K) is less than the range limit (e.g., range limit R or L), but the image X(i, j, k±K) is the first or the last one among images within the j-th subdirectory, the processor 110 may save one or more preloading quotas for preloading the other image, wherein the number of the saved preloading quotas may be equal to the difference between the range limit R and the offset K (i.e., the number of the saved preloading quotas=R−offset K). After determining the images corresponding to the i-th directory to be preloaded, the processor 110 may determine the number of preloaded images of the i-th directory, wherein the more preloading quotas, the fewer the preloaded images. If the number of the preloaded images of the i-th directory is greater than or equal to the count limit O=2R+1, the processor 110 may determine that there no preloading quotas have been saved. If the number of the preloaded images of the i-th directory is less than the count limit O, the processor 110 may determine that one or more preloading quotas have been saved. The processor 110 may preload the image of the directory within the range limit B by the saved preloading quotas until all the preloading quotas are used.

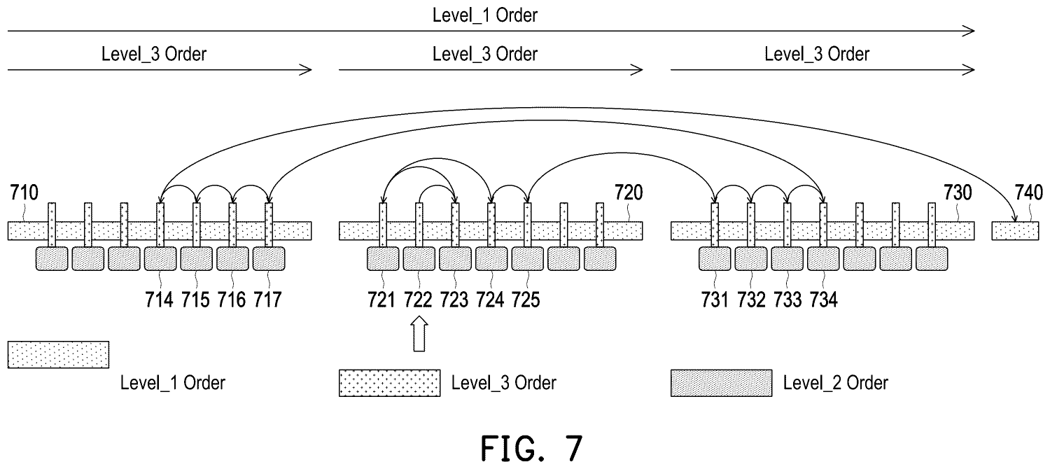

Take FIG. 7 as an example, assume that the count value C=1, the range limit R=3, the range limit B=2, the count limit O=7, and image 722 is currently selected or displayed by the GUI 400. The processor 110 may determine that the offset ‘1’ between the level_3 order (e.g., 2) of the image 722 and the level_3 order (e.g., 1) of the image 721 is less than the range limit R=3, but the image 721 is the first image within a subdirectory (i.e., the subdirectory includes images corresponding to the same level_2 ID or order) of the directory 720. Accordingly, the processor 110 may save two preloading quotas for preloading the other image based on the formula: R−offset ‘1’=3−1=2. The saved preloading quotas may be used for preloading the images within, for example, the directory 740 since the directory 740 is within the range limit B.

In one embodiment, the processor 110 may preload one or more images within the (i±I)-th directory to the cache memory 121 according to the range limit B, wherein I is a positive integer and I≤the range limit B. Specifically, the processor 110 may determine an offset I between the level_1 order of the i-th directory and the level_1 order of the (i±I)-th directory. If the offset I≤B, the processor 110 may preload the image X(i+I, j, 1+K) in the (i+I)-th directory and/or the image X(i−I, j, m−K) in the (i−I)-th directory, wherein m is the maximum level_3 order belonging to the (i−I)-th directory, K is a non-negative integer, and K≤the range limit R. The level_1 order of the image X(i+I, j, 1+K) may satisfy the following formula: i+I≤min(i+B, the largest level_1 order belonging to the directory of data), and the level_3 order of the image X(i+I, j, 1+K) may satisfy the following formula: 1+K≤min(1+R, the largest level_3 order belonging to the (i+I)-th directory). The level_1 order of the image X(i−I, j, m−K) may satisfy the following formula: max(1, i−B)≤i−I, and the level_3 order of the image X(i−I, j, m−K) may satisfy the following formula: max(1, m−R)≤m−K.

Take FIG. 6 as an example, assume that the range limit B=1 and image 624 is currently selected or displayed by the GUI 400. The processor 110 may determine the offset I between the level_1 order (e.g., 2) of the image 624 and the level_1 order (e.g., 3) of the image 631 (or 632, 633) is 1, which is less than or equal to the range limit B=1. Accordingly, the processor 110 may preload the image 631 (or 632, 633) to the cache 121. On the other hand, the processor 110 may determine the offset I between the level_1 order (e.g., 2) of the image 624 and the level_1 order (e.g., 1) of the images 617 (or 616, 615) is 1, which is less than or equal to the range limit B=1. Accordingly, the processor 110 may preload the image 617 (or 616, 615) to the cache 121.

In one embodiment, the processor 110 may preload the image X(i−I, j, m−K) after the image X(i+I, j, 1+K) being preloaded in response to the level_1 order of the image X(i−I, j, m−K) being previous to the level_3 order of the image X(i+I, j, 1+K), wherein m is the maximum level_3 order belonging to the (i−I)-th directory, K is a positive integer, and K≤the range limit R. Take FIG. 6 as an example, since the level_1 order of the images 617, 616, or 615 are previous to the level_1 order of the images 631, 632, or 633, the processor 110 may preload the images 617, 616, or 615 after the images 631, 632, or 633 being preloaded.

In one embodiment, assume that n and m are positive integer and n<m. The processor 110 may preload the image belonging to the (i+m)-th directory after the image belonging to the (i+n)-th directory being preloaded in response to the offset ‘n’ between the level 1 order of the (i+n)-th directory and level_1 order of the i-th directory is less than the offset ‘m’ between the level_1 order of the (i+m)-th directory and level_1 order of the i-th directory. Take FIG. 7 as an example, since the offset ‘1’ between the directory 730 and the directory 720 is less than the offset ‘2’ between the directory 740 and the directory 720, the processor 110 may preload the images within the directory 740 after the images within the directory 730 being preloaded.

In one embodiment, the processor 110 may determine the number of preloaded images. If the number of the preloaded images is less than the count limit A=2O+1=4R+3, the processor 110 may preload more images within the (i+n) directory, wherein n is a positive integer and n≤the range limit B. Take FIG. 7 as an example, assume that the range limit R=3, the range limit B=2, and the count limit A=15. After the images within the directory 710 being preloaded, the processor 110 may determine that the number of preloaded images (i.e., images 714, 715, 716, 717, 721, 722, 723, 724, 725, 731, 732, 733, and 734) within the directories 710, 720 and 730 is 13, which is less than the count limit A=15. Accordingly, the processor 110 may preload the images within the directory 740.

In one embodiment, the processor 110 may stop preloading the images if the difference between the count limit A and the number of the preloaded images is less than the count value C. Take FIG. 8 as an example. Assume that the count limit A=15 and the count value C=2, and the images (e.g., images 816 and 817 within one subdirectory of the directory 810, images 821, 822, and 823 within one subdirectory of the directory 820, or images 831 and 832 within one subdirectory of the directory 830) within two subdirectories of each directory 810, 820, and 830 are already preloaded to the cache 121. The processor 110 may determine that the number of the preloaded images is equal to ‘14’. Since the difference between the count limit A=15 and the number of the preloaded images ‘14’ is less than the count value C=2, the processor 110 may stop preloading the images.

Back to FIG. 2, in step S505, the processor 110 may display one or more images through the GUI 400. The processor 110 may display one or more videos (or images) corresponding to the same level_1 ID based on the count value C and the level_2 order of each video.

In step S506, the processor 110 may determine whether the user switch the page of the GUI 400 through the user command, wherein each page may include one or more selected video (or images). If the page is switched, the processor 110 may select one or more new videos (or images) to be displayed on the GUI 400. After the new videos (or images) are selected, the processor 110 may execute step S503 again. If the page is not switched, the image preloading procedure may be stopped.

FIG. 6 illustrates an example of image preloading according to one embodiment of the present disclosure. Assume that the range limit R=2, the range limit B=2, the count value C=1, the count limit O=2R+1=5, the count limit A=4R+3=11, and the image 624 within the directory 620 is currently selected or displayed by the GUI 400. The processor 110 may determine that the offsets between the level_3 order (e.g., 4) of the image 624 and the level_3 orders (e.g., 2, 3, 5, and 6) of the images 622, 623, 625, and 626 are 2, 1, 1, and 2 respectively, which are less than or equal to the range limit R=2. Accordingly, the processor 110 may preload the images 622, 623, 625, or 626 to the cache 121. The processor 110 may preload the images 623 and 625 first since the offsets between the image 624 and the images 623 and 625 are the smallest offsets. The processor 110 may preload the images 625 first then preload the image 623 in response to the level_3 order of the images 623 being previous to the level_3 order of the image 625. On the other hand, the processor 110 may determine that the offsets K between the level_3 order (e.g., 4) of the image 624 and the level_3 orders (e.g., 1 and 7) of the images 621 and 627 are 3 and 3 respectively, which are greater than the range limit R=2. Accordingly, the processor 110 may not preload the images 621 or 627 to the cache 121.

The processor 110 may determine that the number of the preloaded images is ‘5’, which is less than count limit A=11. Therefore, the processor 110 may preload more images within the directory other than the directory 620. Since the level_1 order of the directory 610 is previous to the level_1 order of the directory 630, the processor 110 may preload the images within the directory 630 first. The processor 110 may preload the images 631, 632, and 633 since the level_3 orders of those images satisfy the formula 1+K≤min(1+R, the largest level_3 order belonging to the (i+I)-th directory) as mentioned above.

The processor 110 may determine that the number of the preloaded images belonging to the directories 620 and 630 is ‘8’, which is less than the count limit A=11. Therefore, the processor 110 may preload more images within the directory 610. The processor 110 may preload the images 617, 616, and 615 since the level_3 orders of those images satisfy the formula max(1, m−R)≤m−K as mentioned above.

FIG. 7 illustrates another example of image preloading according to one embodiment of the present disclosure. Assumed that the range limit R=3, the range limit B=2, the count value C=1, the count limit O=2R+1=7, the count limit A=4R+3=15, and the image 722 within the directory 720 is currently selected or displayed by the GUI 400. The processor 110 may determine that the offsets between the level_3 order (e.g., 2) of the image 722 and the level_3 orders (e.g., 1, 3, 4, and 5) of the images 721, 723, 724, and 725 are 1, 1, 2, and 3 respectively, which are less than or equal to the range limit R=3. Accordingly, the processor 110 may preload the images 721, 723, 724, or 725 to the cache 121. The processor 110 may preload the images 721 and 723 first since the offsets between the image 722 and the images 721 and 723 are the smallest offsets. The processor 110 may preload the image 723 first then preload the image 721 in response to the level_3 order of the image 721 being previous to the level_3 order of the image 723.

The processor 110 may determine that the offset ‘1’ between the level_3 order (e.g., 2) of the image 722 and the level_3 order (e.g., 1) of the image 721 is less than the range limit R=3, but the image 721 is the first image within a subdirectory (i.e., the subdirectory includes images corresponding to the same level_2 ID or order) of the directory 720. Accordingly, the processor 110 may save two preloading quotas for preloading the other image based on the formula: R−offset ‘1’=3−1=2 as mentioned above.

The processor 110 may determine that the number of the preloaded images is ‘5’, which is less than the count limit A=15. Therefore, the processor 110 may proceed to preload the other images. Since the offsets between the directory 720 and the directories 710 and 730 are the smallest offsets and within the range limit B=2, the processor 110 may select one of the directories 710 and 730 to preload the images. The processor 110 may preload the images within the directory 730 first in response to the level_1 order of the directory 710 being previous to the level_1 order of the directory 730. The processor 110 may preload the images 731, 732, 733, and 734 since the level_3 orders of those images satisfy the formula 1+K≤min(1+R, the largest level_3 order belonging to the (i+I)-th directory) as mentioned above. Then, the processor 110 may preload the images within the directory 710 since the number of the preloaded images is ‘9’, which is less than the count value A=15. The processor 110 may preload the images 717, 716, 715, and 714 since the level_3 orders of those images satisfy the formula max(1, m−R)≤m−K as mentioned above.

The processor 110 may determine the number of the preloaded images within the directories 710, 720, and 730 is ‘13’, which is less than the count limit A=15. Therefore, the processor 110 may preload the images within the range limit B by using the saved preloading quotas. For example, the processor 110 may preload two images within the directory 740 by using two preloading quotas.

FIG. 8 illustrates another example of image preloading according to one embodiment of the present disclosure. Assume that the range limit R=3, the range limit B=1, the count value C=2, the count limit O=2R+1=7, the count limit A=4R+3=15, and the two images (e.g., image 822 and another image shares the same level_3 and level_1 order but has a different level_2 order) respectively corresponding to the two subdirectories of the directory 820 are currently selected or displayed by the GUI 400. Since the count value C>1, the processor 110 may determine the range limit L=[(O−C)/2C]=1. The processor 110 may determine the offsets between the level_3 order (e.g., 2) of the image 822 and the level_3 orders (e.g., 1 and 3) of the images 821 and 823 are 1 and 1, which are equal to the range limit L=1. Accordingly, the processor 110 may preload the images 821 and 823 to the cache 121. The processor 110 may preload the image 823 first then preload the image 821 in response to the level_3 order of the image 821 being previous to the level_3 order of the image 823.

The processor 110 may determine the number of the preloaded images of the directory 820 is ‘6’, which is less than the count limit A=15. Therefore, the processor 110 may proceed to preload the other images. Since the offsets between the directory 820 and the directories 810 and 830 are within the range limit B=1, the processor 110 may preload the images within the directories 810 and 830. The processor 110 may preload the images within the directory 830 first then preload the image within the directory 810 in response to the level_1 order of the directory 810 being previous to the level_1 order of the directory 830. The processor 110 may preload the images 831 and 832 since the level_3 orders of those images satisfy the formula 1+K≤min(1+R, the largest level_3 order belonging to the (i+I)-th directory) as mentioned above. Then, the processor 110 may preload the images within the directory 810 since the number of the preloaded images is ‘10’, which is less than the count value A=15. The processor 110 may preload the images 817 and 816 since the level_3 orders of those images satisfy the formula max (1, m−R)≤m−K as mentioned above. The processor 110 may determine the number of the preloaded images is ‘14’. Although the number of the preloaded images ‘14’ is less than the count value A=15, the difference between the count limit A=15 and ‘14’ is less than the count value C=2. Accordingly, the processor 110 may stop preloading the images.

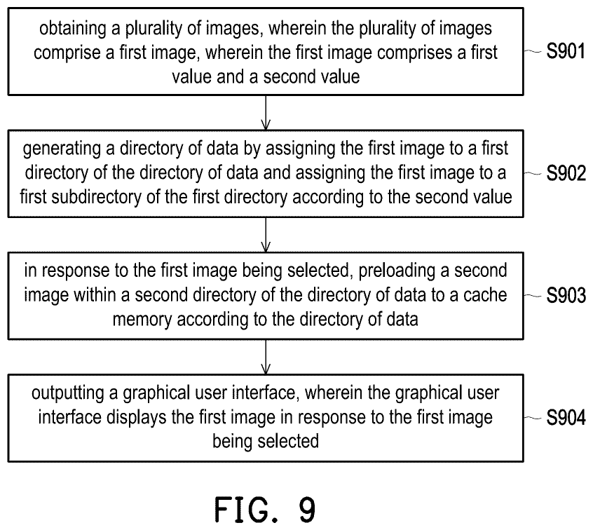

FIG. 9 illustrates a flowchart of a method for image viewing according to one embodiment of the present disclosure, wherein the method may be implemented by the electronic device 100 as shown in FIG. 1. In step S901, obtaining a plurality of images, wherein the plurality of images comprise a first image, wherein the first image comprises a first value and a second value. In step S902, generating a directory of data by assigning the first image to a first directory of the directory of data and assigning the first image to a first subdirectory of the first directory according to the second value. In step S903, in response to the first image being selected, preloading a second image within a second directory of the directory of data to a cache memory according to the directory of data. In step S904, outputting a graphical user interface, wherein the graphical user interface displays the first image in response to the first image being selected.

In summary, the electronic device may create a directory of data according to values included in each of the image. When an image is being selected (or viewed) by the user, the electronic device may preload one or more images adjacent to the selected image in a specific sequence. For example, the electronic device may preload the image from the same video as the selected image, or the image within the same or adjacent directory (or subdirectory) as the selected image. Since the user is more likely to view the image later than the image previous to the selected image, the electronic device may preload the later image with a higher priority. If the selected image is close to the first or the last one in the directory, such that the fewer images need to be preloaded in the directory, the saved preloading quota can be used to preload the image within the adjacent directory of the selected image.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An electronic device for image viewing, comprising:
a transceiver;
a cache memory; and
a processor, coupled to the transceiver and the cache memory, wherein the processor is configured to:
obtain a plurality of images through the transceiver, wherein the plurality of images comprise a first image, wherein the first image comprises a first value and a second value;
generate a directory of data by assigning the first image to a first directory of the directory of data according to the first value and assigning the first image to a first subdirectory of the first directory according to the second value;
in response to the first image being selected, preload a second image within a second directory of the directory of data to the cache memory according to the directory of data; and
output a graphical user interface through the transceiver, wherein the graphical user interface displays the first image in response to the first image being selected.

2. The electronic device according to claim 1, wherein the processor is further configured to:
determine an offset between an order of the first directory in the directory of data and an order of the second directory in the directory of data;
determine whether the offset is less than or equal to a first range limit; and
in response to the offset being less than or equal to the first range limit, preload the second image within the second directory.

3. The electronic device according to claim 2, wherein the processor is further configured to:
preload a third image within a third directory of the directory of data to the cache memory, wherein an order of the third directory in the directory of data is previous to an order of the second directory in the directory of data.

4. The electronic device according to claim 1, wherein the processor is further configured to:
in response to the first image being selected, preload a fourth image within the first subdirectory to the cache memory according to the directory of data.

5. The electronic device according to claim 4, wherein the processor is further configured to:
determine an offset between an order of the first image in the first subdirectory and an order of the fourth image in the first subdirectory;
determine whether the offset is less than or equal to a second range limit; and
in response to the offset being less than or equal to the second range limit, preload the fourth image.

6. The electronic device according to claim 5, wherein the processor is further configured to:
output a graphical user interface through the transceiver, wherein the graphical user interface displays a plurality of videos according to a count value.

7. The electronic device according to claim 6, wherein the processor is further configured to:
determine the second range limit according to the count value.

8. The electronic device according to claim 5, wherein the processor is further configured to:
in response to the offset being less than the second range limit but the fourth image being the first or the last one among images within the first subdirectory or in response to the first image being the first or the last one among the images within the first subdirectory, save a preloading quota;
determine a number of preloaded images of the first directory; and
in response to the number of the preloaded images being less than or equal to a count limit, preload the second images within the second directory by the preloading quota.

9. The electronic device according to claim 5, wherein the processor is further configured to:
preload a fifth image within the first subdirectory to the cache memory after the fourth image being preloaded, wherein an order of the fifth image in the first subdirectory is previous to an order of the fourth image in the first subdirectory.

10. The electronic device according to claim 1, wherein the first image further comprises a third value, wherein the processor is further configured to:
sort the first image in the first subdirectory according to the third value to generate the directory of data.

11. A method for image viewing, comprising:
obtaining a plurality of images, wherein the plurality of images comprise a first image, wherein the first image comprises a first value and a second value;
generating a directory of data by assigning the first image to a first directory of the directory of data and assigning the first image to a first subdirectory of the first directory according to the second value;
in response to the first image being selected, preloading a second image within a second directory of the directory of data to a cache memory according to the directory of data; and
outputting a graphical user interface, wherein the graphical user interface displays the first image in response to the first image being selected.

12. The method according to claim 11, wherein the step of preloading the second image within the second directory of the directory of data to the cache memory according to the directory of data comprising:
determining an offset between an order of the first directory in the directory of data and an order of the second directory in the directory of data;
determine whether the offset is less than or equal to a first range limit; and
in response to the offset being less than or equal to the first range limit, preloading the second image within the second directory.

13. The method according to claim 12, further comprising:
preloading a third image within a third directory of the directory of data to the cache memory, wherein an order of the third directory in the directory of data is previous to an order of the second directory in the directory of data.

14. The method according to claim 11, further comprising:
in response to the first image being selected, preloading a fourth image within the first subdirectory to the cache memory according to the directory of data.

15. The method according to claim 14, wherein the step of preloading the fourth image within the first subdirectory to the cache memory according to the directory of data comprising:
determining an offset between an order of the first image in the first subdirectory and an order of the fourth image in the first subdirectory;
determining whether the offset is less than or equal to a second range limit; and
in response to the offset being less than or equal to the second range limit, preloading the fourth image.

16. The method according to claim 15, further comprising:
outputting a graphical user interface, wherein the graphical user interface displays a plurality of videos according to a count value.

17. The method according to claim 16, further comprising:
determining the second range limit according to the count value.

18. The method according to claim 15, wherein the step of preloading the second image within the second directory of the directory of data to the cache memory according to the directory of data comprising:
in response to the offset being less than the second range limit but the fourth image being the first or the last one within the first subdirectory or in response to the first image being the first or the last one among the images within the first subdirectory, saving a preloading quota;
determining a number of preloaded images of the first directory; and
in response to the number of the preloaded images being less than or equal to a count limit, preloading the second images within the second directory by the preloading quota.

19. The method according to claim 15, further comprising:
preloading a fifth image within the first subdirectory to the cache memory after the fourth image being preloaded, wherein an order of the fifth image in the first subdirectory is previous to an order of the fourth image in the first subdirectory.

20. The method according to claim 11, wherein the first image further comprises a third value, wherein the method further comprises:
sorting the first image in the first subdirectory according to the third value to generate the directory of data.
